(19) United States
(12) Patent Application Publication
(10) Pub. No.: US 2009/0123819 A1
(43) Pub. Date: May 14, 2009

(54) Battery module

(75) Inventor: Tae-Yong Kim, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/217,560

(22) Filed: Jul. 7, 2008

(30) Foreign Application Priority Data
Nov. 12, 2007 (KR) 10-2007-0114936

(51) Int. Cl. H01M 10/50

(52) U.S. Cl. 429/120

(57) ABSTRACT

A battery module for cooling unit batteries by a thermal conductivity method is disclosed. The battery module includes a plurality of unit batteries, a heat sink provided between the unit batteries, and an evaporator connected to the heat sink.

### CROSS-REFERENCE TO RELATED APPLICATION

This application claims priority to and the benefit of Korean Patent Application No. 10-2007-0114936 filed in the Korean Intellectual Property Office on Nov. 12, 2007, the entire content of which is incorporated herein by reference.

### BACKGROUND OF THE INVENTION

(a) Field of the Invention

The present invention relates to a battery module. More particularly, the present invention relates to a battery module for cooling unit batteries by a thermal conductivity method.

(b) Description of the Related Art

A rechargeable battery is capable of being charged and discharged, while a primary battery may not be charged. The rechargeable battery may be classified as a low-capacity battery and a high-capacity battery.

For example, a low-capacity rechargeable battery formed by one unit battery cell is used for small portable electronic devices such as a mobile phone, a laptop computer, and a camcorder. The unit battery cell is formed in various shapes, and typical shapes are a cylinder and a rectangle.

The high-capacity battery formed by a plurality of unit battery packs is used for power sources for driving a motor such as for a hybrid vehicle.

For example, a plurality of unit batteries are coupled in series and combined to be one battery module.

The unit battery includes an electrode group including an anode, a separator, and a cathode. The unit battery also includes a case, including the electrode group, and a cap assembly that is combined to the case to close and seal the case. The cap assembly also includes an electrode terminal electrically connected to the electrode group.

In the battery module, the unit batteries are arranged in a housing with a predetermined interval between the unit batteries, and the respective electrode terminals are connected to each other.

In the battery module, it is required to dissipate heat generated from the plurality of unit batteries. Heat dissipation in the battery module may affect performance of the unit battery and performance of a device (e.g., a hybrid electric vehicle) using the battery module.

Cooling methods of the battery module include an air cooling method using air as a coolant and a water cooling method using water as a coolant.

In the air cooling method, the volume of the battery module increases, and therefore a fan is used to reduce the required volume. The fan generates driving noise and noise caused by air flow.

In the water cooling method, cooling water has excellent cooling performance compared to the cooling performance when air is used. However, in the water cooling method noise is generated by driving a pump, the water may leak to affect the battery module, and a temperature controlling unit is additionally often required.

Therefore, a method having the same excellent performance as the water cooling method without water leakage is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a battery module for cooling unit batteries by a thermal conductivity method.

According to an exemplary embodiment of the present invention, a battery module may include a plurality of unit batteries, a heat sink provided between the unit batteries to be close to the unit batteries, and an evaporator connected to the heat sink.

The heat sink in one embodiment may include a first heat sink and a second heat sink. The first heat sink is formed at one side of two connected unit batteries in a length direction of the unit batteries to be disposed within a half of a length of the two unit batteries. The second heat sink is formed at an opposite side of the first heat sink in the length direction of the unit batteries to be disposed within the other half of the length of the two unit batteries.

The unit battery may be formed in a cylindrical shape, and the heat sink may include a concave groove formed to be less than ¼ of a circumference of the unit battery to contact the circumference of the unit battery. The concave groove may be formed for every ¼ of a circumference formed to correspond to an outermost part of the heat sink. The heat sink may be formed of one of aluminum and steel.

The evaporator in one embodiment may include a first evaporator connected to the first heat sink and a second evaporator connected to the second heat sink at an opposite side of the first evaporator.

The heat sink in one embodiment may be integrally formed to the evaporator.

The heat sink may further include an expanded portion expanded toward the evaporator to contact the evaporator.

The evaporator in one embodiment may further include a fixing plate disposed at a heat sink side to be combined to the evaporator while having the expanded portion between the evaporator and the fixing plate.

The fixing plate may include a penetration hole for supporting the heat sink penetrated through the penetration hole. The evaporator may include a reception groove for receiving the expanded portion.

The battery module in one embodiment may further include an insulating material provided between the unit battery and the heat sink. The insulating material may be formed of a resin or a thermal compound.

The battery module in one embodiment may further include a housing including the unit batteries, the heat sink, and the evaporator. The housing may be filled with nitrogen gas.

### BRIEF DESCRIPTION OF THE DRAWINGS

FIG. 1 is a perspective view of a battery module according to an exemplary embodiment of the present invention.

FIG. 2 is a front view of FIG. 1.

FIG. 3 is a perspective view of the evaporator and the heat sink according to a first exemplary embodiment of the present invention.

FIG. 4 is a partial perspective view of the heat sink, the unit battery, and an insulating material.

FIG. 5 is perspective view of an evaporator and a heat sink according to a second exemplary embodiment of the present invention.

FIG. 6 is an exploded perspective view of FIG. 5.

FIG. 7 is a cross-sectional view along a line VII-VII shown in FIG. 5.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

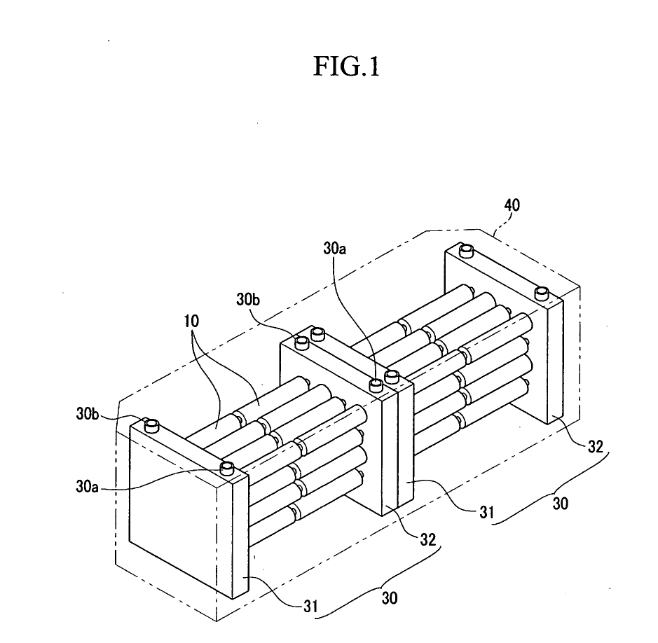

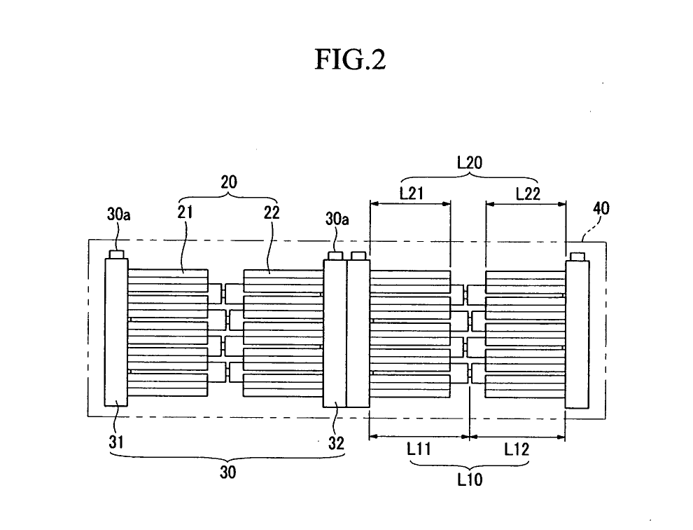

FIG. 1 is a perspective view of a battery module according to an exemplary embodiment of the present invention, and FIG. 2 is a front view of FIG. 1.

Referring to FIG. 1 and FIG. 2, the battery module according to the exemplary embodiment of the present invention includes a plurality of unit batteries 10, a plurality of heat sinks 20, an evaporator 30, and a housing 40.

The unit batteries 10 may be formed in various shapes including a cylindrical shape and a rectangle shape. The unit batteries 10 are coupled in series to output large power.

The unit batteries 10 are formed to generate the power, and may be formed by batteries that have been disclosed. Detailed descriptions of an operation of the unit battery 10 will be omitted.

The heat sinks 20 are inserted between neighboring unit batteries 10 to be close to the unit batteries 10. Heat generated from the unit battery 10 is conducted through the heat sinks 20.

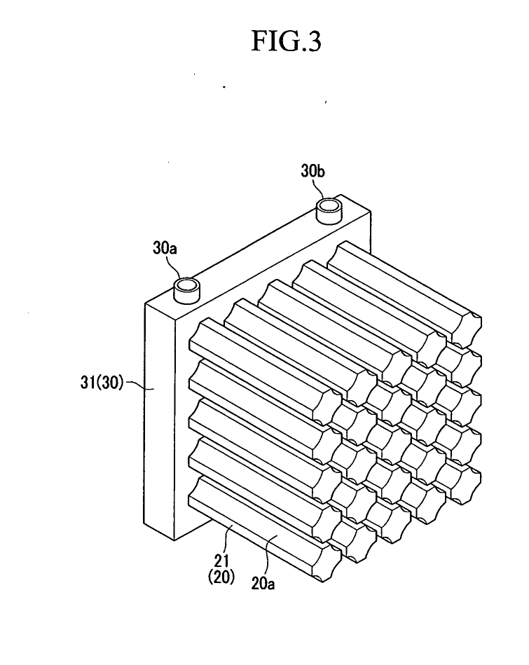

FIG. 3 is a perspective view of the evaporator and the heat sinks according to a first exemplary embodiment of the present invention.

Referring to FIG. 3, the heat sinks 20 are disposed between the unit batteries 10, and the heat sinks 20 surround contours of the unit batteries 10.

Each heat sink 20 is disposed in parallel with a length direction of a unit battery 10. Referring back to FIG. 1 and FIG. 2, one heat sink or two heat sinks (not shown) may be formed for each unit battery. In addition, one heat sink (not shown) or two heat sinks may be formed for connected unit batteries 10.

In the first exemplary embodiment of the present invention, two unit batteries 10 are coupled in series, and two heat sinks 20 are formed for the connected two unit batteries 10. That is, the heat sink 20 includes a first heat sink 21 and a second heat sink 22 that are disposed in parallel with a length direction of the unit battery 10.

The first heat sink 21 is formed at one side of the connected unit batteries 10 and the second heat sink 22 is formed at another side of the connected unit batteries 10 (i.e., an opposite side of the first heat sink 21).

In this case, a sum L20 (=L21+L22) of lengths L21 and L22 of the first heat sink 21 and the second heat sink 22 is not greater than a sum L10 (=L11+L12) of lengths L11 and L12 of the unit batteries 10.

Therefore, the length L21 of the first heat sink 21 is less than ½ of the length L10 of the two unit batteries 10 (L21≦½*L10), and the first heat sink is formed to be close to the unit battery 10.

In addition, the length L22 of the second heat sink 22 is less than ½ of the length L10 of the two unit batteries 10 (L21≦½*L10), and the second heat sink 22 is formed to be close to the unit battery 10.

The first heat sink 21 performs a thermal conductivity function in a half of the length L10 of the unit batteries 10, and the second heat sink 22 performs the thermal conductivity in the other half of the length L10. Therefore, the connected unit batteries 10 have thermal equilibrium on the both sides.

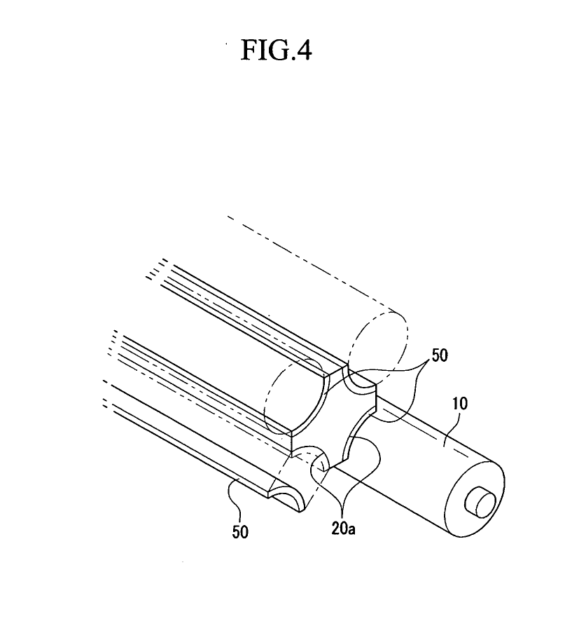

FIG. 4 is a partial perspective view of the heat sink, the unit battery, and an insulating material.

Referring to FIG. 4, the unit battery 10 is formed in a cylindrical shape. The heat sink 20 has a concave groove 20a so that the heat sink 20 contacts the unit battery 10. The concave groove 20a contacts a circumference of the unit battery 10, and is formed to be less than ¼ of the circumference of the unit battery 10.

The concave groove 20a is formed for every ¼ of a circumference (not shown) formed to correspond to an outermost part of the heat sink 20. That is, four concave grooves 20a may be formed in one heat sink 20. In this case, the unit batteries 10 may be disposed on four sides of one heat sink 20.

The heat sink 20 may be formed of aluminum or steel having excellent thermal conductivity. For example, the heat sink 20 may be integrally formed with the evaporator 30 by using a welding method (see FIG. 3).

In addition, an insulating material 50 is closely provided between the unit battery 10 and the heat sink 20. The insulating material 50 prevents a short-circuit between the unit batteries 10, and it may be formed of a resin or a thermal compound having excellent thermal conductivity.

The evaporator 30 is connected to the heat sink 20 positioned between the unit batteries 10 to be protruded in a length direction of the unit battery 10. The evaporator 30 cools an end of the heat sink 20 for performing the thermal conductivity function.

A low temperature and high pressure coolant supplied from a condenser (not shown) is passed through the evaporator 30, and the evaporator 30 expands it to be a high temperature and high pressure coolant to absorb heat around the evaporator 30.

The evaporator 30 includes an inlet 30a and an outlet 30b that are connected to the condenser to respectively receive and output a coolant. For example, in a hybrid electric vehicle, the evaporator 30 receives a low temperature and high pressure coolant from a condenser of an air conditioner (not shown).

That is, the heat sink 20 uses the evaporator 30 to perform high heat dissipation. Since the coolant is circulated in the evaporator 30, a problem of cooling water leakage from the unit batteries 10 may be solved.

Since the evaporator 30 is connected to the heat sink 20, the evaporator 30 may be formed according to a configuration of the heat sink 20.

The evaporator 30 includes a first evaporator 31 and a second evaporator 32. The first evaporator 31 is connected to the first heat sink 21, and the second evaporator 32 is connected to the second heat sink 22 at an opposite side of the first evaporator 31.

The first evaporator 31 and the second evaporator 32 cool the first heat sink 21 and the second heat sink 22 at both sides of the connected unit batteries 10.

The housing 40 includes the unit batteries 10, the heat sink 20, and the evaporator 30 to form the battery module.

In the first exemplary embodiment of the present invention, the battery module includes two sets including the first and second evaporators 31 and 32 and the connected unit batteries 10 disposed between the first and second evaporators 31 and 32.

The housing 40 may includes nitrogen N₂ gas to prevent condensation caused by a temperature difference between the inside and outside of the housing 40.

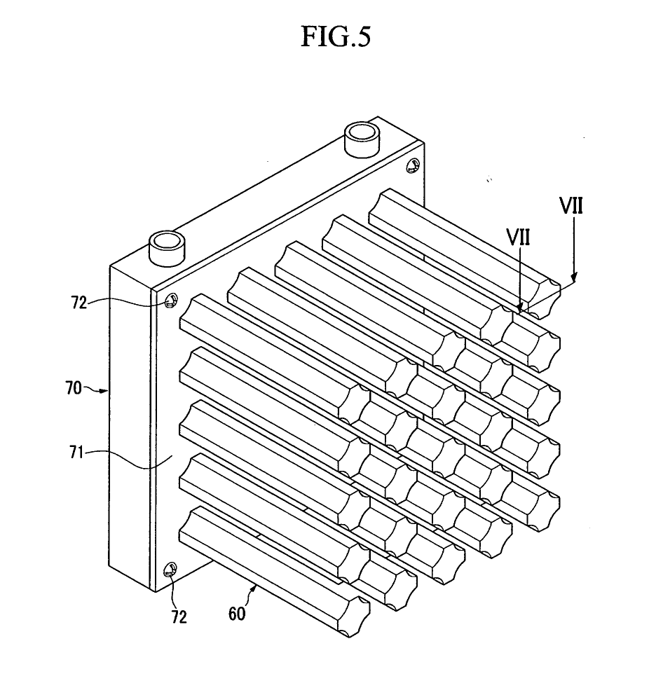

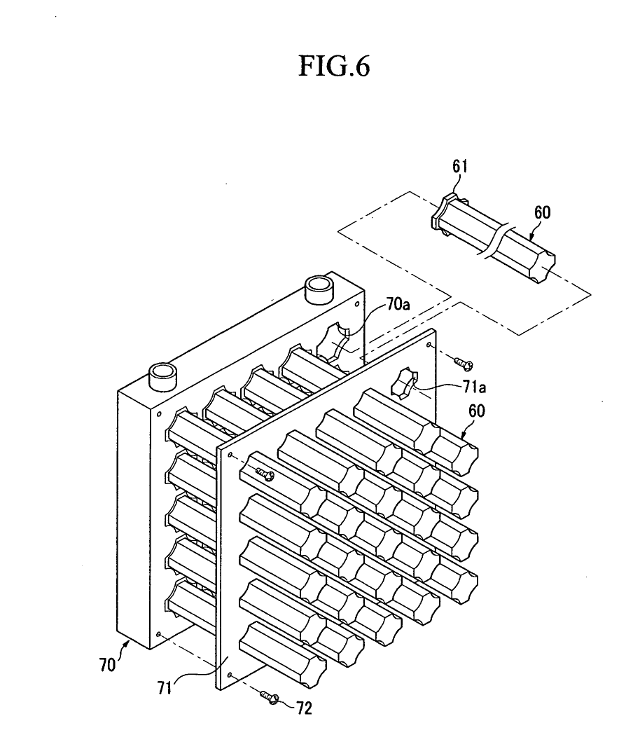

FIG. 5 is perspective view of an evaporator and heat sinks according to a second exemplary embodiment of the present invention, and FIG. 6 is an exploded perspective view of FIG. 5.

Referring to FIG. 5 and FIG. 6, since an operation and a configuration of the second exemplary embodiment of the present invention is the same as or similar to those of the first exemplary embodiment of the present invention, descriptions of parts having been described will be omitted.

A heat sink 60 includes an expanded portion 61 expanded toward an evaporator 70. Since the expanded portion 61 is expanded and formed at an end of the heat sink 60, heat may be more quickly conducted from the heat sink 60 to the evaporator 70.

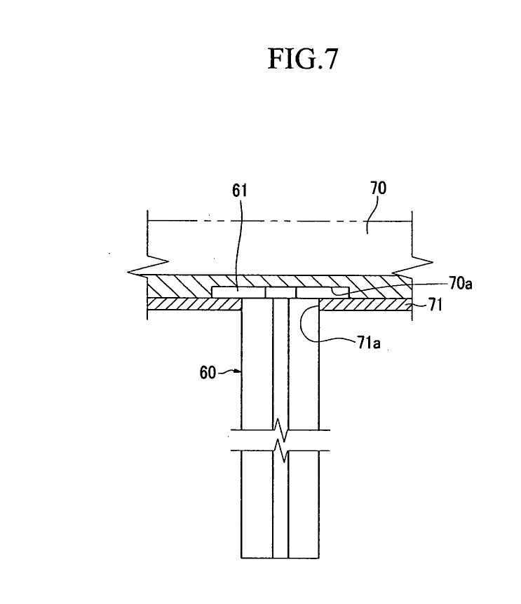

The evaporator 70 further includes a fixing plate 71. The fixing plate 71 is disposed on the evaporator 70 at a heat sink 60 side, and is combined to the evaporator 70 by using a fastening member 72 while having the expanded portion 61 between the evaporator 70 and the fixing plate 71 (see FIG. 7).

The fixing plate 71 includes a penetration hole 71a corresponding to the heat sinks 60. The heat sink 60 is penetrated through the penetration hole 71a, and the penetration hole 71a supports the heat sink 60.

The evaporator 70 includes a reception groove 70a formed to correspond to the expanded portion 61. The reception groove 70a forms a wide contact area along with the expanded portion 61 to perform quick thermal conductivity, and more firmly support the heat sink 60.

As described, since the heat sink inserted between the unit batteries is connected to the evaporator in the battery module according to the exemplary embodiment of the present invention, heat generated from the unit battery may efficiently output.

In addition, since the battery module according to the exemplary embodiment of the present invention does not use a fan or cooling water, noise caused by the fan may not be generated, and a leakage problem may not be caused.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A battery module comprising:
a plurality of unit batteries;
a heat sink provided between the unit batteries to be close to the unit batteries; and
an evaporator connected to the heat sink.

2. The battery module of claim 1, wherein the heat sink comprises:
a first heat sink formed at one side of two connected unit batteries in a length direction of the unit batteries to be disposed within a half of a length of the two unit batteries; and
a second heat sink formed at an opposite side of the first heat sink in the length direction of the unit batteries to be disposed within the other half of the length of the two unit batteries.

3. The battery module of claim 2, wherein the unit battery is formed in a cylindrical shape, and
the heat sink comprises a concave groove formed to be less than ¼ of a circumference of the unit battery to contact the circumference of the unit battery.

4. The battery module of claim 3, wherein the concave groove is formed for every ¼ of a circumference formed to correspond to an outermost part of the heat sink.

5. The battery module of claim 1, wherein the heat sink is formed of one of aluminum and steel.

6. The battery module of claim 2, wherein the evaporator comprises:
a first evaporator connected to the first heat sink; and
a second evaporator connected to the second heat sink at an opposite side of the first evaporator.

7. The battery module of claim 1, wherein the heat sink is integrally formed to the evaporator.

8. The battery module of claim 1, wherein the heat sink further comprises an expanded portion expanded toward the evaporator to contact the evaporator.

9. The battery module of claim 8, wherein the evaporator further comprises a fixing plate disposed at a heat sink side to be combined to the evaporator while having the expanded portion between the evaporator and the fixing plate.

10. The battery module of claim 9, wherein the fixing plate comprises a penetration hole for supporting the heat sink penetrated through the penetration hole.

11. The battery module of claim 10, wherein the evaporator comprises a reception groove for receiving the expanded portion.

12. The battery module of claim 1, further comprising an insulating material provided between the unit battery and the heat sink.

13. The battery module of claim 1, wherein the insulating material is formed of a resin or a thermal compound.

14. The battery module of claim 1, further comprising a housing comprising the unit batteries, the heat sink, and the evaporator.

15. The battery module of claim 14, wherein the housing is filled with nitrogen gas.

16. A battery module comprising:
a plurality of unit batteries wherein the plurality of unit batteries extend in a first direction and are arranged so as to be positioned parallel and proximate to each other;
at least one heat sink structure interposed between the plurality of unit batteries so as to be interposed between adjacent unit batteries to thereby absorb heat generated by the plurality of unit batteries;
an evaporator coupled to the heat sink structure so as to remove heat absorbed by the heat sink structure.

17. The battery module of claim 16, wherein the unit batteries are cylindrical in shape and the at least one heat sink structure defines a structure having a plurality of grooves sized and shaped to receive the plurality of unit batteries.

18. The battery module of claim 17, wherein the at least one heat sink structure comprises a first and a second heat sink structure and wherein the plurality of unit batteries are arranged so as to be positioned parallel and proximate to each other and to define a first and a second end and wherein the first heat sink structure is positioned proximate to the first ends of the plurality of unit batteries and the second heat sink structure is positioned proximate to the second ends of the plurality of unit batteries.

19. The battery module of claim 16, wherein the at least one heat sink structure is integrally formed to the evaporator.

20. The battery module of claim 16, wherein the at least one heat sink structure defines an expanded portion at the evaporator defines an opening sized to receive the expanded portion and wherein the module further comprises a fixing plate that secure the at least one heat sink structure to the evaporator.
